(19) United States
(12) Patent Application Publication
(10) Pub. No.: US 2022/0306161 A1
(43) Pub. Date: Sep. 29, 2022

(54) Method for detecting inconsistencies in the outputs of perception systems of autonomous vehicles

(71) Applicant: IVEX, Leuven (BE)

(72) Inventors: Quentin De Clercq, Brussels (BE); Hoang Tung Dinh, Heverlee (BE); Mario Henrique Cruz Torres, Heverlee (BE); Danilo Romano, Salerno (IT); Patrick Abrahao, Oud-Heverlee (BE); Victor Vaquero, Heverlee (BE)

(21) Appl. No.: 17/678,398

(22) Filed: Feb. 23, 2022

(30) Foreign Application Priority Data
Mar. 25, 2021 (BE) 2021/5227

(51) Int. Cl. B60W 60/00

(52) U.S. Cl. CPC B60W 60/0027; B60W 2554/4042; B60W 2554/4044; B60W 2552/53; B60W 2552/00; B60W 2420/42; B60W 2420/52; B60W 2556/60

(57) ABSTRACT

A system and method for the detection of inconsistencies in perception systems of autonomous vehicles is described. The system receives the observations of objects in the surrounding environment from one or more sensors or perception systems of an automated vehicle. At actual time, the system estimates the consistency of the currently observed elements of the perception system according to the previous inputs received. This consistency is decided by calculating the boundaries of possible states of the previously observed elements, based on the received information and on assumptions.

### CROSS REFERENCE TO RELATED APPLICATIONS

This application takes priority and claims the benefit of Belgian Patent Application No. 2021/5227 filed on Mar. 25, 2021, the contents of which are herein incorporated by reference.

### BACKGROUND

Automated vehicles (also referred to as autonomous vehicles) are robotic platforms with several perceptive sensors for obtaining raw measurements about the surrounding environment. The raw measurements are further processed by perception systems, which attribute a model of the environment allowing the vehicle control and decision-making unit to act accordingly and to appropriately maneuver in the traffic.

Existing perception systems for automated vehicles can detect and track elements from the scene and the environment. Those systems detect the objects from the scene with an object detection algorithm based on single and multiple sensors, such as camera, LiDAR or Radar. Then, the object type and object state are estimated. At the same time, the new object is checked and associated with past detected objects.

However, there is no quality assurance system for the observed information at runtime. The best that a detection and tracking system can do is to provide a score representing the uncertainty of the detection and tracking results.

Assessing the quality of the perception systems of automated vehicles at runtime is highly desirable. Perception systems are the initial point for any further interaction of automated vehicles with the environment. Hence, errors at perception systems can propagate to actions taken by the automated vehicles that can be catastrophic when maneuvering, especially in shared spaces with humans.

Perception systems are imperfect and non-robust. Additionally, state-of-the-art perception stacks in autonomous driving embodiments are based on non-explainable architectures such as deep neural networks. Guaranteeing the quality of these perception systems is still a major challenge. Thus, it is vital to assess the quality of automated vehicles' perception systems at runtime. If the quality of these perception systems is degraded, the vehicle control unit should be informed immediately so that it can avoid taking unsafe decisions and actions.

In the real world, at runtime, there is no ground-truth information about the surrounding objects and the environment. Ground-truth is generally understood as the real and exact position and status of the elements of the scene. Without that information, assessing the quality of perception systems at runtime without human supervision is not trivial.

### SHORT DESCRIPTION OF THE INVENTION

The inventors now have surprisingly found a system and method for analyzing the proper evolution of the driving scene and detecting inconsistencies in the outputs of perception systems of automated vehicles at runtime in order to increase the safety of automated vehicles and similar robotic platforms.

Safety concerns about the perceived information are identified through the system and method of this invention. Each time a new result from the perception system arrives, it is compared with past results for detecting inconsistencies. The new result is also stored for a fixed period of time, for example, 2 seconds, for future comparisons. The comparison is done by first propagating the past results over a short period of time to the future, based on different assumptions about the behavior of each object. The propagation computes the boundary of all possible future states of the object. Then, the newly estimated state of the object is checked to see whether it stays within the computed boundary.

Accordingly, the first object of the invention is a computer-implemented method for detecting inconsistencies in the information from the perception sensors (1.1) and the perception systems (1.2), hereinafter jointly referred to as observations, of an automated vehicle (1) and running on an electronic control unit (1.3), which comprises the steps of:
a. receiving and storing the observed states of the scene from perception systems (1.2) and sensors (1.1),
b. calculating the boundaries of one or more possible states of a previously observed object at a given timestamp based on the nature of the object, the previous states of the object, the assumptions on the behavior of the object, or the environmental conditions, or a combination thereof,
c. checking whether an estimated state of a scene or object stays within the calculated expected boundaries,
d. sending a notification when an estimated state does not stay within a expected boundary to the electronic control unit (1.3),
e. optionally having the electronic control unit perform safety actions based on the notification of step d.

In another aspect, the inconsistency detection system is free of human supervision and control.

In another aspect, the observed states of the scene are objects, road shapes, or environmental conditions or combinations thereof.

In another aspect, the observed and estimated states of scenes, objects, road shapes, or environmental conditions or combinations thereof are stored and then used to calculate the boundaries of states of scenes and objects in the future or to match current observed states with future observed states.

In another aspect, the observed and estimated states are stored for a fixed period of time, wherein the fixed period is between 0.1 seconds and 10 seconds, preferably between 1 second and 5 seconds, even more preferably between 1.5 seconds and 3 seconds.

In another aspect, the estimated states are updated or stored when new information about it is received.

In another aspect, the boundaries of possible states of an object or a scene are calculated at a given timestamp.

In another aspect, the boundaries are calculated based on one or more of the following parameters and features:
the previous bounding box of the object,
the previous velocity of the object,
the previous acceleration of the object,
the previous heading of the object,
the shapes of the road or the lane markings,
the assumption on the maximum acceleration of the object,
the assumption on the minimum acceleration of the object, which can be negative,
the assumption on the maximum velocity of the object,
the assumption on the minimum velocity of the object,
the assumption on the space boundary that the object could reach.

In another aspect, the assumptions are defined for one or more of following object types comprising:
Pedestrian,
Bike,
Motorbike,
Passenger car,
Truck,
Emergency vehicles, or

Or one or more of the following scene type classifications comprising:
Highway,
Urban road
Regional road, or

Or one or more environmental conditions comprising:
Rain,
Sun,
Fog,
Storm,
Day, or
Night.

In another aspect, the assumptions are a combination of types and conditions comprising:
Highway road at night in rainy conditions, or
Urban road at day in sunny conditions.

In another aspect, the calculated boundaries are one or more of the following parameters and features:
the maximum and minimum velocity of the object,
the occupancy space of the object, represented by the maximum and minimum on each axis of a coordinate system.
the environmental conditions and scene types, representing that they should not drastically change within the analysed time-window.

In another aspect, the coordinate systems comprise:
A 2D cartesian coordinate system,
A 3D cartesian coordinate system, or
A 2D or a 3D Frenet coordinate system.

In another aspect, the assumption about the new velocities and positions of the objects based acceleration of the objects are calculated as follows:

v_max=previous_v+a_max*delta_t

v_min=previous_v+a_min*delta_t

p_max=previous_p_max+previous_v*delta_t+0.5*a_max*delta_t\hat{ }2

p_min=previous_p_min+previous_v*delta_t+0.5*a_min*delta_t\hat{ }2.

In another aspect, the assumption about the maximum and minimum velocities of the objects are calculated as follows:

v_max=min(previous_v+a_max*delta_t,v_assumption_max)

v_min=max(previous_v+a_min*delta_t,v_assumption_min)

In another aspect, it is checked
whether an estimated bounding box of the object stays within the boundaries defining the maximum and minimum position of the bounding box, and
whether the estimated velocity of the object stays within the boundaries defining the maximum and minimum velocity
or if any of those

In another aspect, the perceived scene type, and environmental conditions, or combinations of types and conditions as described above are analyzed and matched through the time interval.

In another aspect, a notification is sent when the estimated state of the object stays outside the calculated boundaries, preferably via CAN bus. Actions developed after receiving this signal, such as for example to trigger an emergency maneuver are optional for the system, and not under the scope of the invention.

Another object of the invention is a data processing system for detecting inconsistencies in the observations from perception systems (1.2) and perception sensors (1.1) of an automated vehicle (1) and running on an electronic control unit (1.3), comprising means for carrying out the steps of:
a. receiving and storing the observed states of the scene from perception systems (1.2) and sensors (1.1),
b. calculating the boundaries of one or more possible states of a previously observed object at a given timestamp based on the previous states of the object, the assumptions on the behavior of the object, or the evolution of the scene type and/or environmental conditions, or a combination thereof,
c. checking whether an estimated state of a scene or object stays within the calculated boundaries,
d. sending of a notification when an estimated state does not stay within a calculated boundary to the electronic control unit (1.3),
e. optionally having the electronic control unit perform safety actions based on the notification of step d.

Another object of the invention is a computer-readable medium having stored instructions to cause the computer to perform the steps of the inconsistency detection method of the present invention.

Another object of the invention is an AD/ADAS vehicle comprising the data processing system of the invention, or the computer readable medium of the invention.

### SHORT DESCRIPTION OF THE DRAWINGS

FIG. 1 is a schematic flow chart of the inconsistency detector system of the present invention in an autonomous vehicle.

FIG. 2 is a flow chart of the method for the detection of inconsistencies in autonomous vehicles of the present invention.

### DETAILED DESCRIPTION OF THE DRAWINGS

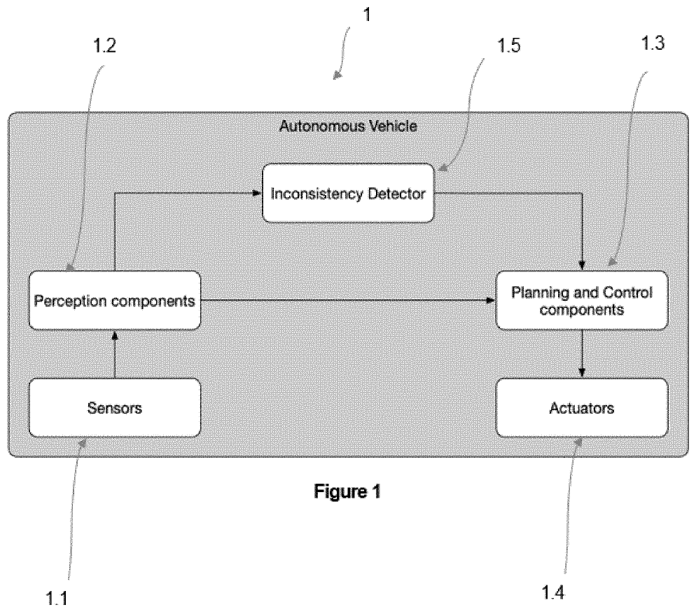

FIG. 1 is a schematic flow chart of the inconsistency detector system of the present invention in an autonomous vehicle system (1). The information from the environment measured by sensors (1.1) is directed to the perception systems (1.2) of the automated vehicle. Examples of sensors include:
Cameras,
Light Detection And Ranging, also referred to as LiDAR,
Radars, or
Global Navigation Satellite System positioning, also referred to as GNSS positioning.

The perception systems (1.2) of the vehicle interpret the raw information from the sensors (1.2) and extract observations on the scene. Such observations include one or more of the existing elements, their position, or environmental conditions.

The vehicle central board (1.3) is capable of performing several vehicle processes, such as vehicle control and decision making units that perform tasks such as path planning. The outputs of the vehicle central board (1.3) are executed by the vehicle actuators (1.4).

The inconsistency detector system (1.5) of the present invention monitors information from the sensors (1.1) and the perception systems (1.2), hereinafter jointly referred to as observations. The inconsistency detector system (1.5) informs the vehicle central board (1.3) about the reliability of those observations.

The system is running on an electronic control unit including one or more processors and a memory. The memory may include one or more instructions which can be executed by one or more processors causing the detection of inconsistencies from the input observations received at the electronic control unit.

The system receives observations of the scene and objects in the surrounding environment from one or more sensors (1.1) or from one or more perception systems (1.2) in the vehicle. The system may receive additional input from road information such as shape of the road, curvature, traffic status, or surface condition or a combination thereof. The system may also receive additional input such as environmental conditions including the position of the sun, weather, or humidity.

In another embodiment, the system receives the observations at a single time or during an interval comprising consecutive times.

In another embodiment, the system receives previously stated input, observations and times.

In general, each observation obtained from the real scene observed by the sensors (1.1) or the perception systems (1.2) generates one or several observation states in the inconsistency system associated to a time. Each observed state is stored for a fixed period of time. For example, an observed state may be stored for 2 seconds.

In subsequent times, the current observed state system inputs are updated to estimated states. The estimated states are obtained by calculating the boundaries of the possible states of the objects or the scene, hereinafter referred to as state boundaries.

The calculation of the state boundaries is based on one or more of the following parameters and features:
the previously received observations,
the assumptions on the behavior or aspect of the object, and
the road information and environmental conditions received.

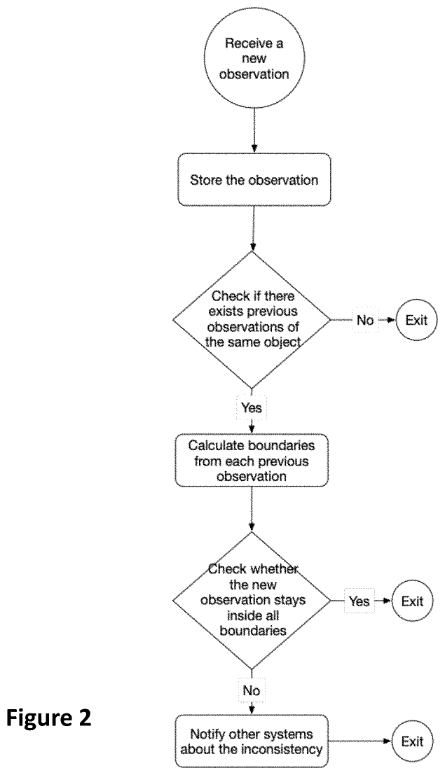

Once the current observations are received, the inconsistency detection system (1.5) evaluates their consistency as shown in FIG. 2.

In a first step, the inconsistency detector system (1.5) checks for each new observed state, whether there exists previously stored estimated states of the same object or scene.

If there are no previously stored estimated states of the same object or full or partial scene, the system does not perform an inconsistency check.

If there are previously stored estimated states of the same object or full or partial scene, the system performs an inconsistency check. The inconsistency check consists of assessing whether or not the current observed state lies in the estimated state boundaries. If the new observed state is outside of the calculated boundaries, the inconsistency detection system (1.5) will consider the output of the perception system (1.2) or of the sensors (1.1) as inconsistent.

If an inconsistency is detected, the inconsistency detection system sends a notification to the control units in the vehicle to act accordingly and safely. With this signalization, the control units can perform appropriate actions to mitigate the inconsistency such as informing other subsequent systems as for example systems responsible for planning, decision making and control on the autonomous vehicle.

In one embodiment, the actions taken by the control system (1.4) that receives the inconsistency system signals of sensor or perception inconsistencies are not under the scope of this invention.

TABLE 1
English expressions used in the drawings for translation purposes:

| | |
|---|---|
| Autonomous vehicle | Autonoom voertuig |
| Sensor | Sensor |
| Perception component | Perceptie-element |
| Inconsistency detector | Inconsistentiedetector |
| Planning and control components | Onderdelen voor planning en regeling |
| Actuators | Actuatoren |
| Receive a new observation | Ontvang een nieuwe waarneming |
| Check if there exists previous | Controleer of er eerdere |
| observations of the same object | waarnemingen van hetzelfde object |
| | bestaan |
| Yes | Ja |
| No | Nee |
| Exit | Exit |
| Calculate boundaries from each | Bereken de grenzen van iedere |
| previous observation | voorgaande waarneming |
| Check whether the new | Controleer of de nieuwe waarneming |
| observation stays inside | binnen alle grenzen blijft |
| all boundaries | |
| Notify other systems about the | Informeer andere systemen over de |
| inconsistency | inconsistentie |

What is claimed is:

1. A computer-implemented method for detecting inconsistencies in the observations from perception systems (1.2) and perception sensors (1.1) of an automated vehicle (1) and running on an electronic control unit (1.3), which comprises the steps of:
a. receiving and storing the observed states of the scene and environment from perception systems (1.2) and sensors (1.1),
b. calculating the boundaries of one or more possible states of a previously observed object at a given timestamp based on the previous states of the object, the assumptions on the behavior of the object, or the type of scene, or the environmental conditions, or a combination thereof,
c. checking whether an estimated state of a scene or object stays within the calculated boundaries obtained in step b,
d. sending a notification when an estimated state does not stay within a calculated boundary to the electronic control unit (1.3),
e. optionally having the electronic control unit perform safety actions based on the notification of step d.

2. The inconsistency detection method of claim 1, wherein the observed states of the scene are objects, road shapes, or environmental conditions or combinations thereof.

3. The inconsistency detection method of claim 1, wherein the observed and estimated states of scenes, objects, road shapes, or environmental conditions or combinations thereof are stored and then used to calculate the boundaries of states of objects in the future or to match current observed states with future observed states.

4. The inconsistency detection method of claim 1, wherein the observed and estimated states are stored for fixed period of time, wherein the fixed period is comprised between 0.1 seconds and 10 seconds, preferably between 1 second and 5 seconds, even more preferably between 1.5 seconds and 3 seconds.

5. The inconsistency detection method of claim 1, wherein the observed and estimated states are stored until new information about the same object is received.

6. The inconsistency detection method of claim 1, wherein boundaries of possible states of an object or a scene are calculated at a given timestamp.

7. The inconsistency detection method of claim 1, wherein the boundaries are calculated based on one or more of:
a. the previous bounding box of the object,
b. the previous velocity of the object,
c. the previous acceleration of the object,
d. the previous heading of the object,
e. the shapes of the road or the lane markings,
f. the assumption on the maximum acceleration of the object,
g. the assumption on the minimum acceleration of the object, which can be negative,
h. the assumption on the maximum velocity of the object,
i. the assumption on the minimum velocity of the object,
j. the assumption on the space boundary that the object could reach,
k. the assumption on the environment conditions fluctuation.

8. The inconsistency detection method of claim 1, wherein the calculated boundaries are one or more of the following values:
a. the maximum and minimum velocity of the object,
b. the occupancy space of the object, represented by the maximum and minimum on each axis of a coordinate system.

9. The inconsistency detection method of claim 1, wherein the coordinate systems comprise:
a. A 2D cartesian coordinate system,
b. A 3D cartesian coordinate system, or
c. A 2D or a 3D Frenet coordinate system.

10. The inconsistency detection method of claim 1, wherein the assumption about the acceleration of the objects are calculated as follows:
v_max=previous_v+a_max*delta_t a.
v_min=previous_v+a_min*delta_t b.
p_max=previous_p_max+previous_v*delta_t+0.5*a_max*delta_t\hat{ }2 c.
p_min=previous_p_min+previous_v*delta_t+0.5*a_min*delta_t\hat{ }2. d.

11. The inconsistency detection method of claim 1, wherein the assumption about the acceleration and velocity of the objects are calculated as follows:
v_max=min(previous_v+a_max*delta_t,v_assumption_max); a.
v_min=max(previous_v+a_min*delta_t,v_assumption_min) b.
